(19) United States
(12) Patent Application Publication
(10) Pub. No.: US 2025/0304089 A1
(43) Pub. Date: Oct. 2, 2025

(54) METHOD AND SYSTEM FOR NAVIGATION SUPPORT OF AN ELECTRIC VEHICLE TOWING A TRAILER

(71) Applicants: HYUNDAI MOTOR COMPANY, Seoul (KR); Kia Corporation, Seoul (KR)

(72) Inventors: Michael Schreiber, Frankfurt am Main (DE); Benjamin LUCAS, Kelsterbach (DE); Alejandro CEPEDA, Frankfurt am Main (DE)

(73) Assignees: HYUNDAI MOTOR COMPANY, Seoul (KR); Kia Corporation, Seoul (KR)

(21) Appl. No.: 18/951,535

(22) Filed: Nov. 18, 2024

(30) Foreign Application Priority Data
Mar. 28, 2024 (EP) 24167280.7

(51) Int. Cl. B60W 50/14; B60L 53/66; G01C 21/34

(52) U.S. Cl. CPC B60W 50/14; B60L 53/66; G01C 21/3469; B60L 2200/28; B60L 2240/60

(57) ABSTRACT

In method and system for navigation support of an electric vehicle towing a trailer, the method for navigation support of an electric vehicle (EV) towing a trailer includes specifying, by a navigation system of the EV, a destination of the EV for a planned trip with the EV via a navigation system of the EV; detecting, by a trailer detection device of the EV, that a trailer is connected to the EV; assessing, by the navigation system, charging stations along potential routes for the specified destination that are suitable for recharging the EV in a state that the trailer is connected to the EV; and at least one of: indicating the suitable charging stations via the navigation system; and determining candidate routes for the planned trip by the navigation system based on the specified destination and the suitable charging stations.

### CROSS-REFERENCE TO RELATED APPLICATION

The present application claims priority to European Patent Application No. 24167280.7 filed in the European Patent Office on Mar. 28, 2024, the entire contents of which is incorporated herein for all purposes by this reference.

### BACKGROUND OF THE PRESENT DISCLOSURE

### Field of the Present Disclosure

The present disclosure relates to a method and a system for navigation support of an electric vehicle towing a trailer as well as to an electric vehicle with such a system.

### Description of Related art

Electrification is an ongoing trend in the automotive sector and electric charging is often considered to be a crucial bottleneck in the present respect. Charging an electric vehicle may become particularly challenging when towing a trailer. On the one hand, the electric range of the vehicle may be severely affected by the presence of the trailer. On the other hand, it may be difficult to find a suitable charging station and/or a suitable charging slot at a specific charging station as the trailer may extend the external dimensions of the vehicle significantly, in particular in length direction, and common charging stations may not take into account such an increased space demand. Even considering that some charging stations may feature dedicated elongated charging slots for vehicles with trailers, it may be difficult for the user to know in advance about the actual situation at specific charging stations along a planned route. Having to decouple a trailer first to facilitate charging is inconvenient and may not be desirable for security reasons amongst others.

Generally, a method for operating an electrically driven vehicle, wherein the state of charge of an electric battery is optimized by predicting the recuperated energy during the next trip under consideration of the presence of a trailer, is known. Amongst others, a brake force of the trailer is optimized to reach the best possible recuperation.

Generally, a method to improve energy and range prediction by taking trailer characteristics into account, which is eventually used to optimize route planning for the vehicle, is known.

Some vehicles are able to automatically detect the presence of a trailer and can thus adapt their operation, in particular the battery management, as soon as this has happened. Generally, a method predicting the range of an electric vehicle including monitoring a trailer detecting means of the vehicle and determining a range value if the trailer detecting means detects that a trailer is currently attached to the vehicle, is known.

### BRIEF SUMMARY

Various aspects of the present disclosure are directed to providing solutions for supporting electric vehicles with trailers in finding suitable charging opportunities.

To the present end, various aspects of the present disclosure are directed to providing a method in accordance with claim 1, a system in accordance with claim 6 and an electric vehicle in accordance with claim 11.

According to one aspect of the present disclosure, a method for navigation support of an electric vehicle (EV) towing a trailer includes specifying, by a navigation system of the EV, a destination of the EV for a planned trip with the EV via a navigation system of the EV; detecting, by a trailer detection device of the EV, that a trailer is connected to the EV; assessing, by the navigation system, charging stations along potential routes for the specified destination that are suitable for recharging the EV in a state that the trailer is connected to the EV; and at least one of: indicating the suitable charging stations via the navigation system; and determining candidate routes for the planned trip by the navigation system based on the specified destination and the suitable charging stations.

According to another aspect of the present disclosure, a system for navigation support of an EV towing a trailer includes a trailer detection device configured to detect that a trailer is connected to the EV; and a navigation system configured to specify a destination of the EV for a planned trip with the EV, to assess charging stations along potential routes for the specified destination that are suitable for recharging the EV in a state that the trailer is connected to the EV and at least one of: indicate the suitable charging stations; and determine candidate routes for the planned trip based on the specified destination and the suitable charging stations.

According to yet another aspect of the present disclosure, an electric vehicle includes a system according to an exemplary embodiment of the present disclosure.

One idea of the present disclosure is to assist a vehicle operator in finding charging stations where the trailer will not have to be decoupled to be able to charge the vehicle. To the present end, the present disclosure indicates appropriate charging stations that are suitable for charging a vehicle with connected trailer. A charging station may be suitable in this regard, for example, because it has one or several charging slots with increased free space for vehicles with unusual length.

A trailer detection device is provided to determine whether a trailer is present and coupled to the vehicle. If this is the case, then the navigation system provides the operator with the relevant information related to suitable charging stations and/or is configured to determine recommended routes for the vehicle based on the locations of these charging stations.

For example, the trailer detection device may check whether a multi-pole electrical trailer connector or other such device is coupled to the trailer. The trailer detection device may receive feedback from the trailer via such a connector, for example a confirmation that the trailer is (correctly) coupled to the vehicle. In case of advanced connectors additional information may be transferred via the connection, e.g., control and/or monitoring data, trailer configuration data including information on the spatial extension and the weight of the trailer, etc.

However, a trailer detection device in the sense of the present disclosure may alternatively, or additionally, include sensor elements (e.g., one or several cameras etc.) provided on or at the vehicle that detect a coupled trailer at the rear of the vehicle and may in addition determine its size or extensions.

Yet Furthermore, trailer detection systems may be employed that detect the trailer on basis of the changed driving behavior of the vehicle with trailer compared to without trailer. Typically, it takes these systems some time to detect a trailer on the present basis, e.g., a few kilometers and/or some minutes of driving. In other words, these systems are often only able to detect the load of a trailer coupled to the vehicle sometime after the vehicle has started its trip.

It is understood that the term “vehicle” or “vehicular” or other similar term as used herein is inclusive of electric vehicles in general such as passenger vehicles including sports utility vehicles (SUV), buses, trucks, various commercial vehicles, and the like, and not only includes battery electric vehicles but also hybrid vehicles like plug-in hybrid electric vehicles and the like. As referred to herein, a hybrid vehicle is a vehicle that has two or more sources of power, for example both gasoline-powered and electric-powered vehicles.

Advantageous embodiments and improvements of the present disclosure are found in the subordinate claims.

According to an exemplary embodiment of the present disclosure, the navigation system may consider trailer configuration data characterizing a size of the trailer, and/or charging station configuration data specifying available parking space at the charging stations, in assessing suitable charging stations. A charging station may be considered suitable if the EV fits onto a charging slot of the respective charging station together with the trailer in a state that the trailer is connected to the EV.

Hence, the system may take into account trailer characteristics like for example length, height, width, weight, number of axles and the like. Additionally, or alternatively, the system may also consider characteristics of each charging station, in particular the size of individual charging points/slots at each such station (in case there are several). It is to be understood that the system may consider various additional aspects of the charging stations like for example the number of charging slots, the charging capacity at each slot etc.

The trailer configuration data may be provided to the vehicle manually, e.g., by the operator, and/or automatically, e.g., from the trailer via an electronic trailer connector or via a wireless network after the type of trailer has been identified by the operator and/or the vehicle. In other exemplary embodiments of the present disclosure, the trailer detection device may also obtain information on the trailer characteristics via sensor elements on the vehicle, for example.

Information on each charging station may be available in a data repository of and/or connected to the navigation system and/or may be provided online via a wireless network to the vehicle.

According to an exemplary embodiment of the present disclosure, detecting may include determining that a device is connected to the EV at a tow hitch of the EV and excluding that the device is a bicycle carrier or similar equipment.

Hence, the system may double-check whether a trailer is actually connected or whether other devices are coupled to the vehicle that may not have a relevant impact on the required space at a charging station. A typical example of such a device is a bicycle carrier mountable to the tow hitch of the vehicle, which is typically not critical at charging stations as it does not require a significant amount of extra space at the rear of the vehicle.

According to an exemplary embodiment of the present disclosure, the method may further include wirelessly communicating, by a communication system of the EV, charging information after a successful charging process at a charging station with connected trailer indicating that the charging station is a suitable charging station. The system may thus include a correspondingly configured communication system.

Hence, a fleet of electric vehicles towing trailers may participate to continuously update the available information on the relevant charging stations and may share the information with the other vehicles and/or with a central repository.

According to an exemplary embodiment of the present disclosure, the charging information may include trailer configuration data characterizing a size of the trailer, and/or charging station configuration data specifying available parking space at the charging stations.

The present disclosure will be explained in greater detail with reference to exemplary embodiments depicted in the drawings as appended.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The accompanying drawings are included to provide a further understanding of the present disclosure and are incorporated in and constitute a part of the present specification. The drawings illustrate the exemplary embodiments of the present disclosure and together with the description serve to explain the principles of the present disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically discloses an electric vehicle with a system for navigation support of the electric vehicle while towing a trailer according to an exemplary embodiment of the present disclosure.

FIG. 2 schematically shows differently configured charging stations for recharging the electric vehicle of FIG. 1.

FIG. 3 schematically shows an exemplary route provided by the system of FIG. 1.

FIG. 4 shows a flow diagram of a method for navigation support of the electric vehicle of FIG. 1.

Although predetermined embodiments are illustrated and described herein, it will be appreciated by those of ordinary skill in the art that a variety of alternate and/or equivalent implementations may be substituted for the predetermined embodiments shown and described without departing from the scope of the present disclosure. Generally, the present application is directed to cover any adaptations or variations of the predetermined embodiments discussed herein.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

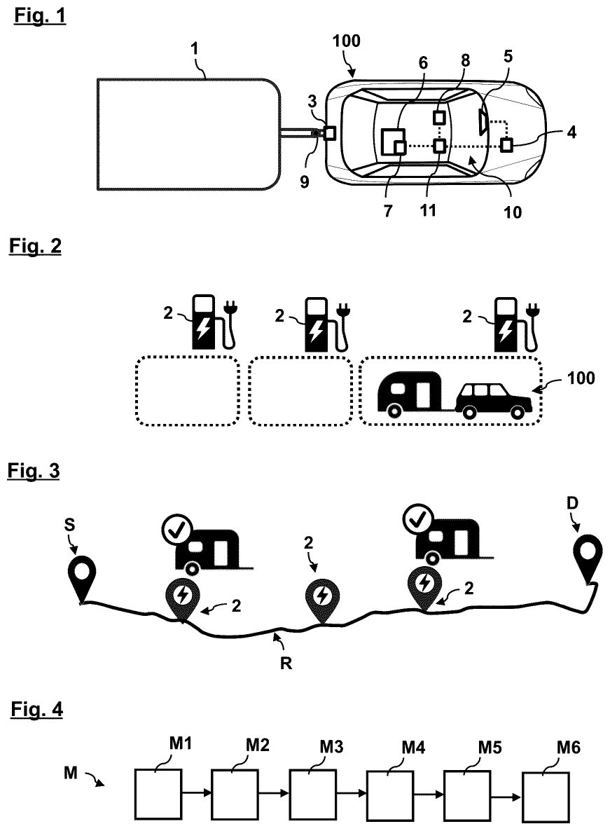

FIG. 1 schematically discloses an electric vehicle 100 (EV) with a system 10 for navigation support of the EV 100 while towing a trailer 1 according to an exemplary embodiment of the present disclosure. In the exemplary application of the system 10 as described in the following, the EV 100 tows a camping trailer. It is to be understood, however, that the system 10 may be applied in a similar vein to any kind of trailer which may be coupled to an electric vehicle.

Charging such an EV 100 with a hooked trailer 1 may be challenging because typical charging stations may not provide enough parking space at each charging slot for the EV 100 together with its trailer 1. If an operator decides to charge the EV 100 nonetheless, the trailer 1 may block the adjacent road/lane and/or may block other chargers or charging slots. In addition, decoupling the trailer 1 from the EV 100 to charge the EV 100 may raise a security issue, e.g., a decoupled trailer 1 may get stolen during charging.

Even if some charging stations or charging slots work with trailers, the corresponding information may not be available to the drivers. FIG. 2 shows an exemplary arrangement of several charging stations 2. Two of these charging stations 2, i.e., left and middle charging stations 2 do not offer enough free space for the EV 100 together with its trailer 1 and only the charging station 2 on the right hand side provides enough free space so that the EV 100 fits onto the charging slot together with its trailer 1. Hence, the EV 100 may be recharged without having to decouple the trailer 1 and without blocking the adjacent slots or road.

The present disclosure improves on the above situation by providing assistance to the vehicle operators to find suitable charging stations 2 where the trailer 1 does not need to be decoupled.

To the present end, this system 10 includes a trailer detection device 3 configured to detect that the trailer 1 is connected to the EV 100.

For example, the trailer detection device 3 may be configured to check whether an electrical trailer connector is coupled to the trailer 1, e.g., it may check whether the respective multi-pole plug is connected between the EV 100 and the trailer 1.

In other examples, the trailer detection device 3 may also obtain information related to a coupled trailer 1 by evaluating the driving behavior of the EV 100, which differs in case the trailer 1 is coupled to the vehicle and will depend on the type of trailer 1.

In yet further examples, the trailer detection device 3 may include one or several sensor elements provided on or at the EV 100 and configured to monitor the rear of the EV 100, in particular the tow hitch 9, and may further include a controller to determine whether the trailer 1 is coupled to the EV 100 and/or what type of trailer 1 it is.

Furthermore, the trailer detection device 3 may be configured to determine that a device is connected to the EV 100 at a tow hitch 9 of the EV 100 and to exclude that the present device is a bicycle carrier or similar equipment for detecting that the trailer 1 is connected to the EV. Also to the present end, the trailer detection device 3 may check whether the trailer connector is coupled or not and may rely on additional sensor data.

Referring to FIG. 1, the system 10 further includes a navigation system 4 configured to specify a destination D of the EV 100 for a planned trip with the EV 100 and to assess charging stations 2 along potential routes R for the specified destination D that are suitable for recharging the EV 100 in a state that the trailer 1 is connected to the EV 100.

To the present end, the navigation system 4 is configured to consider trailer configuration data characterizing a size of the trailer 1, e.g., length, height, width, weight, number of axles etc. The information of trailer configuration data may be provided, for example, automatically to the EV 100 and its navigation system 4 when the trailer 1 is coupled to the EV 100 via an electronic trailer connector. Alternatively, or additionally, respective information may be entered manually into the navigation system 4 by an operator of the EV 100. It may be sufficient to type in the trailer model, and based on this, the navigation system 4 may then obtain the size and other parameters of the trailer 1 from an online or offline data repository. Moreover, respective data may be provided by the trailer detection device 3 connected to the navigation system 4, for example, based on obtained sensor data etc.

The navigation system 4 is further configured to consider charging station configuration data specifying available parking space at the charging stations 2. The charging station configuration data may thus provide information on whether there is enough parking space at one or several charging slots at a charging station 2 for the EV 100 together with its coupled trailer 1. The respective information may be shared wirelessly with the navigation system 4 and may be continuously updated, as explained below.

The navigation system 4 considers both the trailer configuration data and the charging station configuration data in assessing suitable charging stations 2. A charging station 2 may be considered suitable if the EV 100 fits onto a charging slot of the respective charging station 2 together with the trailer 1 while the trailer 1 is connected to the EV.

The navigation system 4 is then further configured to indicate the suitable charging stations 2 to the vehicle operator. For instance the navigation system 4 may highlight the charging stations 2 with easy trailer access on a navigation map or show only the charging stations 2 with easy trailer access. In addition, the navigation system 4 may be further configured to determine one or several candidate routes R for the planned trip based on the specified destination D and the suitable charging stations 2.

FIG. 3 shows an exemplary case. The navigation system 4 optimizes a route R between a starting point S and a destination D by suggesting charging stations 2 where the vehicle operator does not have to decouple the trailer 1. In the depicted example, three charging stations 2 are situated along the route R of the EV 100, two of which are considered as suitable for charging with attached trailer 1, i.e., the left and the right ones in FIG. 3. This information, as well as the route planning, may take into account the specific configuration of the trailer 1 actually coupled to the EV 100. Hence, the recommended route R, as well as the charging stations 2 considered to be suitable, may differ for different types of trailers 1.

Referring to FIG. 1, the system 10 further includes a communication system configured to wirelessly communicate charging information after a successful charging process at a charging station 2 with connected trailer 1 indicating that the charging station 2 is a suitable charging station. The communication system is connected to the navigation system 4.

In other words, the information on suitable charging stations 2 may be generated and continuously updated in an automatized fashion based on fleet intelligence, i.e., each EV 100 with trailer 1 may send a message to a server if charging has been completed and whether it has been executed with or without decoupling the trailer 1. If many (e.g., 50+%) of charging actions with hooked trailer I have been completed without decoupling, the respective charging station 2 or charging slot/point may be classified as “trailer friendly” by the server. The respective procedure may consider individual charging slots/points at each charging station 2 (if available) to take into account that not all charging points at one charging station 2 have the same available space and thus may not be configured identically.

Hence, a fleet of electric vehicles towing trailers may participate to continuously update the available information on the relevant charging stations and may share the information with the other vehicles and/or with a central repository through the server.

FIG. 4 shows a corresponding method M for navigation support with the system 10 described above. The method M includes method M1 of specifying a destination D for a planned trip with the EV 100 via the navigation system 4. The method M further includes method M2 of detecting by the trailer detection device 3 that the trailer 1 is connected to the EV 100. The method M further includes method M3 of assessing, by the navigation system 4, charging stations 2 along potential routes R for the specified destination D that are suitable for recharging the EV 100 while the trailer 1 is connected to the EV 100. The method M further includes method M4 indicating the suitable charging stations 2 via the navigation system 4 and method M5 determining candidate routes R for the planned trip by the navigation system 4 based on the specified destination D and the suitable charging stations. Moreover, the method M includes method M6 wirelessly communicating by the communication system charging information after a successful charging process at a charging station 2 with connected trailer 1 indicating that the charging station 2 is a suitable charging station 2.

It will be clear to the person of skill, that the present system 10 may also consider its knowledge about the coupled trailer 1 and its configuration into account to provide an improved and optimized control of the vehicle and in particular of its electric battery 6 (via a respective battery management system 7), as it is described, for example, in DE 10 2021 204 100 A1.

In addition, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for navigation support of an electric vehicle (EV) towing a trailer, the method comprising:
specifying, by a navigation system of the EV, a destination of the EV for a planned trip with the EV;
detecting, by a trailer detection device of the EV, that the trailer is connected to the EV;
assessing, by the navigation system, charging stations along potential routes for the specified destination that are suitable for recharging the EV in a state that the trailer is connected to the EV; and
at least one of:
indicating the suitable charging stations via the navigation system; and
determining candidate routes for the planned trip by the navigation system based on the specified destination and the suitable charging stations.

2. The method of claim 1,
wherein the navigation system is configured to consider at least one of trailer configuration data characterizing a size of the trailer, and charging station configuration data specifying available parking space at the charging stations, in assessing the suitable charging stations, and
wherein a charging station is considered suitable in response that the EV fits onto a charging slot of the charging station together with the trailer in a state that the trailer is connected to the EV, among the charging stations.

3. The method of claim 1, wherein the detecting includes:
determining that a device is connected to the EV at a tow hitch of the EV; and
excluding that the device is a bicycle carrier or similar equipment.

4. The method of claim 1, further including:
wirelessly communicating, by a communication system of the EV, charging information indicating that a charging station is a suitable charging station after a successful charging process at the charging station with the connected trailer.

5. The method of claim 4, wherein the charging information includes at least one of trailer configuration data characterizing a size of the trailer, and charging station configuration data specifying available parking space at the charging stations.

6. The method of claim 1, further including:
transmitting information on the suitable charging stations to a sever to share the information with a fleet of electric vehicles via the server.

7. A system for navigation support of an electric vehicle (EV) towing a trailer, the system comprising:
a trailer detection device configured to detect that the trailer is connected to the EV; and
a navigation system configured to specify a destination of the EV for a planned trip with the EV, to assess charging stations along potential routes for the specified destination that are suitable for recharging the EV in a state that the trailer is connected to the EV,
wherein the navigation system is further configured to performing at least one of:
indicating the suitable charging stations; and
determining candidate routes for the planned trip based on the specified destination and the suitable charging stations.

8. The system of claim 7,
wherein the navigation system is further configured to consider at least one of trailer configuration data characterizing a size of the trailer, and charging station configuration data specifying available parking space at the charging stations, in assessing the suitable charging stations, and
wherein a charging station is considered suitable in response that the EV fits onto a charging slot of the charging station together with the trailer in a state that the trailer is connected to the EV.

9. The system of claim 7, wherein the trailer detection device is configured to determine that a device is connected to the EV at a tow hitch of the EV and to exclude that the device is a bicycle carrier or similar equipment for detecting that the trailer is connected to the EV.

10. The system of claim 7, further including:
a communication system configured to wirelessly communicate charging information indicating that a charging station is a suitable charging station after a successful charging process at the charging station with the connected trailer.

11. The system of claim 10, wherein the charging information includes at least one of trailer configuration data characterizing a size of the trailer, and charging station configuration data specifying available parking space at the charging stations.

12. The system of claim 7, wherein the navigation system is further configured to transmit information on the suitable charging stations to a sever to share the information with a fleet of electric vehicles via the server.

13. An electric vehicle with the system of the claim 7.

14. A non-transitory computer readable storage medium on which a program for performing the method of claim 1 is recorded.
